(19) United States
(12) Patent Application Publication
(10) Pub. No.: US 2011/0161818 A1
(43) Pub. Date: Jun. 30, 2011

(54) METHOD AND APPARATUS FOR VIDEO CHAPTER UTILIZATION IN VIDEO PLAYER UI

(75) Inventor: Timo-Pekka Viljamaa, Helsinki (FI)

(73) Assignee: NOKIA CORPORATION, Espoo (FI)

(21) Appl. No.: 12/648,419

(22) Filed: Dec. 29, 2009

(51) Int. Cl. G06F 3/01

(52) U.S. Cl. 715/720

(57) ABSTRACT

A method, apparatus, user interface and computer program product for detecting a video clip in a mobile communication device, generating video chapter thumbnails from the video clip, providing the video chapter thumbnails in a video player user interface of the mobile communication device, and wherein selection of a video chapter thumbnail will enable a playback from a corresponding video clip chapter.

### TECHNICAL FIELD

The aspects of the disclosed embodiments generally relate to video players devices, and in particular to presenting and visualizing video clips in a video player of a mobile communication device.

### BACKGROUND

Current advances in mobile and wireless technology are making it easier to access multimedia contents anywhere and anytime. Multimedia content can include, but is not limited to, a video, a video segment, a keyframe, an image, a graph, a figure, a drawing, a picture, a text, a keyword, and other suitable contents. Multimedia contents can be viewed on small mobile device, such as a PDA, a cell phone, a Tablet PC, a Pocket PC, and other suitable electronic devices. The small mobile device can utilize an associated input device such as a pen or a stylus to interact with a user. However, it is challenging to browse multimedia content on the small mobile device. The small screen area of such device restricts the amount of multimedia content that can be displayed. User interaction tends to be more tedious on the small mobile device, and the limited responsiveness of the current generation of such devices is another source of aggravation. Due to bandwidth and performance issues, it is necessary to carefully select the portions of the multimedia content to transmit over a network. Furthermore, despite the high portability and flexibility of the small mobile devices serving as mobile multimedia terminals, how they handle and process multimedia contents huge in term of number of bytes generally is a big challenge, because the resources of these small mobile devices are potentially limited.

Current video players generally require a desktop computer to create video chapters in order to browse and play video clips. It is also difficult to be able to jump to specific preview frame from the whole video clip.

Accordingly, it would be desirable to address at least some of the problems identified above.

### SUMMARY

Various aspects of examples of the invention are set out in the claims.

According to a first aspect a method includes detecting a video clip in a mobile communication device, generating video chapter thumbnails from the video clip, providing the video chapter thumbnails in a video player user interface of the mobile communication device, and wherein selection of a video chapter thumbnail will enable a playback from a corresponding video clip chapter.

In a second aspect, an apparatus includes a processor configured to detect a video clip in a mobile communication device, generate video chapter thumbnails from the video clip, provide the video chapter thumbnails in a video player user interface of the mobile communication device, and wherein selection of a video chapter thumbnail will enable a playback from a corresponding video clip chapter.

In another aspect, a computer program product includes a computer readable storage medium bearing computer program code embodied therein for use with a computer, the computer program code having code for detecting a video clip in a mobile communication device, code for generating video chapter thumbnails from the video clip, code for providing the video chapter thumbnails in a video player user interface of the mobile communication device, and wherein selection of a video chapter thumbnail will enable a playback of a corresponding video clip chapter

### BRIEF DESCRIPTION OF THE DRAWINGS

For a more complete understanding of the example embodiments, reference is now made to the following descriptions taken in connection with the accompanying drawings, in which:

FIG. 1 is a block diagram of an exemplary device incorporating aspects of the disclosed embodiments;

FIGS. 2A-2I are screenshots illustrating aspects of the disclosed embodiments;

FIG. 3 is a flowchart illustrating aspects of the disclosed embodiments;

FIGS. 4A and 4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE DRAWINGS

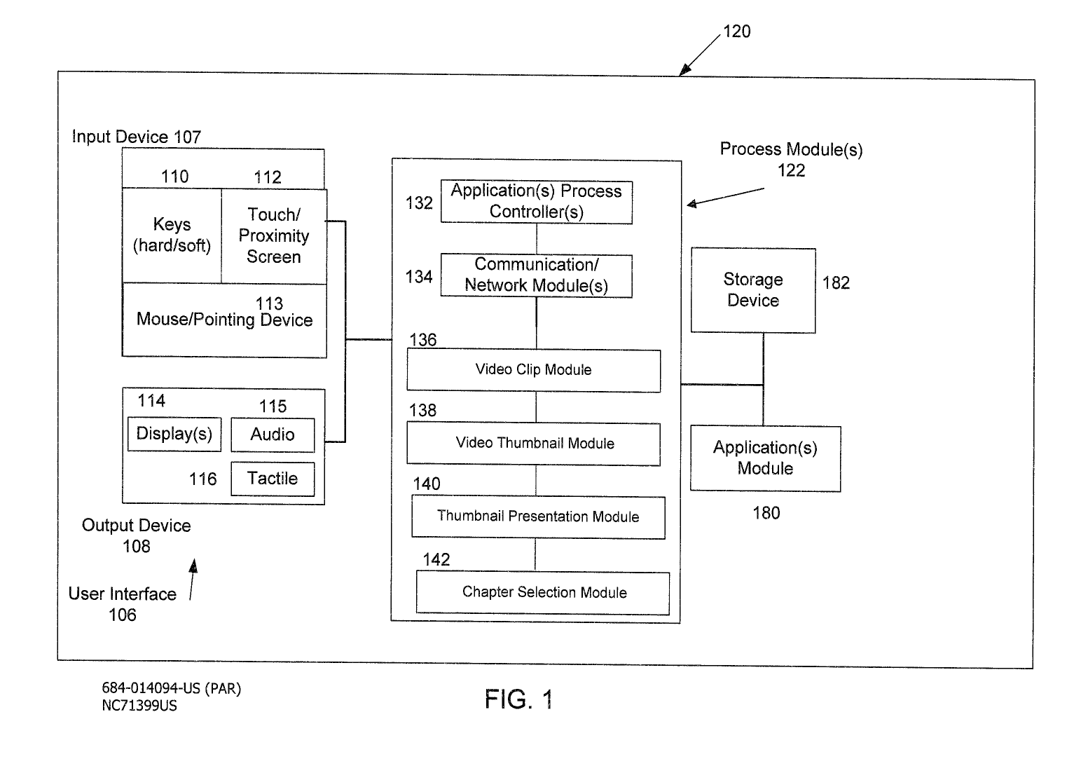

Example embodiments of the present application and its potential advantages are understood by referring to FIGS. 1-6 of the drawings. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments are generally directed to enabling the browsing of any video clip in a mobile device without the need to use a desktop computer to create the video chapters. The video clip is downloaded to the mobile device and divided into segments, which in one embodiment can be of a fixed length. Alternatively, the lengths can vary between segments. The segments are then presented in a fashion that allows for the video clips associated with each segment to be viewed.

FIG. 1 illustrates one embodiment of an exemplary communication device or apparatus 120 that can be used to practice aspects of the disclosed embodiments. The communication device 120 of FIG. 1 generally includes a user interface 106, process module(s) 122, application module(s) 180, and storage device(s) 182. In alternate embodiments, the device 120 can include other suitable systems, devices and components that enable use of a device 120 when in a locked state. The components described herein are merely exemplary and are not intended to encompass all components that can be included in, or used in conjunction with the device 120. The components described with respect to the device 120 will also include one or more processors or computer program products to execute the processes, methods, sequences, algorithms and instructions described herein.

The user interface 106 of the device 120 generally includes input device(s) 107 and output device(s) 108. The input device(s) 107 are generally configured to allow for the input of data, instructions, information gestures and commands to the device 120. The input device 107 can include one or a combination of devices such as, for example, but not limited to, keys or keypad 110, touch sensitive area 112 or proximity screen and a mouse or pointing device 113. In one embodiment, the keypad 110 can be a soft key or other such adaptive or dynamic device of a touch screen 112. The input device 107 can also be configured to receive input commands remotely or from another device that is not local to the device 120. The input device 107 can also include camera devices (not shown) or other such image capturing system(s).

The output device(s) 108 is generally configured to allow information and data to be presented to the user and can include one or more devices such as, for example, a display 114, audio device 115 and/or tactile output device 116. In one embodiment, the output device 108 can also be configured to transmit information to another device, which can be remote from the device 120. While the input device 107 and output device 108 are shown as separate devices, in one embodiment, the input device 107 and output device 108 can comprise a single device, such as for example a touch screen device, and be part of and form, the user interface 106. For example, in one embodiment where the user interface 106 includes a touch screen device, the touch sensitive screen or area 112 can also serve as an output device, providing functionality and displaying information, such as keypad or keypad elements and/or character outputs in the touch sensitive area of the display 114. While certain devices are shown in FIG. 1, the scope of the disclosed embodiments is not limited by any one or more of these devices, and alternate embodiments can include or exclude one or more devices shown.

The process module 122 is generally configured to execute the processes and methods of the aspects of the disclosed embodiments. The process module 122 can include hardware, software and application logic, or a combination thereof. As described herein, the process module 122 is generally configured to copy or download a video clip, divide the video clip into a series of chapters, where, in one embodiment, each chapter has a substantially equal length, and generate a video chapter thumbnail for each chapter that is then presented on the display 114 of the device 120. Although the segments and chapters are described with respect to being of equal length, in one embodiment, the chapters and segments can be of different lengths, based on for example, image recognition methods. Chapters can also be created and structured so that the start of a chapter is never a black frame.

Once the segments or chapters are generated, the user can select any one of the video chapter thumbnails in order to play the corresponding video clip chapter. The video chapter thumbnails can be displayed in a details layer as a grid or film strip view. The video chapter thumbnails can be panned and searched, and the user can jump between different video chapter thumbnails.

The application process controller 132 shown in FIG. 1 is generally configured to interface with the application module 180 and execute applications processes with respect to the other components and modules of the device 120. In one embodiment the application module 180 is configured to interface with applications that are stored either locally to or remote from the device 120. The application module 180 can include any one of a variety of applications that may be installed, configured or accessible by the device 120, such as for example, contact applications and databases, office and business applications, media server and media player applications, video and video processing applications, multimedia applications, web browsers, global positioning applications, navigation and position systems, and map applications. The application module 180 can also include a voice recognition system that includes a text-to-speech module that allows the user to receive and input voice commands, prompts and instructions, through a suitable audio input device. In alternate embodiments, the application module 180 can include any suitable application that can be used by or utilized in the processes described herein.

The communication module 134 shown in FIG. 1 is generally configured to allow the device 120 to receive and send communications and data including for example, telephone calls, text messages, push to talk cellular service, location and position data, navigation information, chat messages, multimedia data and messages, video and email. The communications module 134 is also configured to receive information, data and communications from other devices and systems or networks, such as for example, the Internet. In one embodiment, the communications module 134 is configured to interface with, and establish communications connections with other services and applications using the Internet. In one embodiment, the communication module 134 is configured to interface with and/or download video data and files, such as video clips, to the device 120 from a suitable device or service, such as for example, a personal computer, a media server or the Internet.

The video download module 136 is generally configured to copy, download and/or store a video clip, also referred to as a video file, that is received from the communication module 134. A video clip or video file, as those terms are used herein, is generally intended to include media that includes both “clips” and longer media or movie files. In one embodiment, the video download module 136 is configured to download the video data directly from the source of the video data. The video or video clip can be of any suitable size, length and format. For example, videos can be downloaded from the Internet, recorded with a device camera, synchronized from a desktop computer or network hard drive/media server, or received via e-mail, Bluetooth™, MMS, instant messaging, chat or other such suitable application or protocol.

The process modules 122 can also include a video thumbnail module 138. The video thumbnail module 138 is generally configured divide the video clip into different segments, also referred to herein as chapters. In one embodiment, the chapters are of substantially equal length, which can be based on the length of the video. For example, if the video has a length of two hours, the video can be divided into five-minute segments or chapters. If the video clip is two-minutes in length, then the video clip can be divided into 15-second segments. In alternate embodiments, the video or video clip can be divided into any suitable length segments or chapters. In one embodiment, the video thumbnail module 138 receives the downloaded or stored video, and determine from the length of the video, the length of the segments. The segment length can be stored or established in a settings menu or function of the device 120. The video is then divided into the determined number of segments, each of which is then designated as, and referred to herein, as a thumbnail view, or video chapter thumbnail.

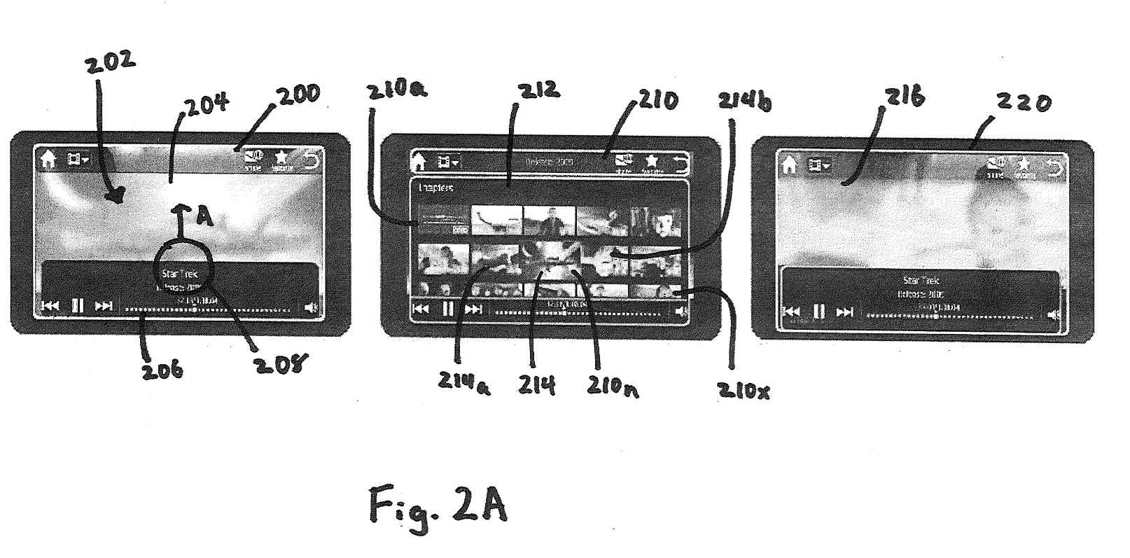

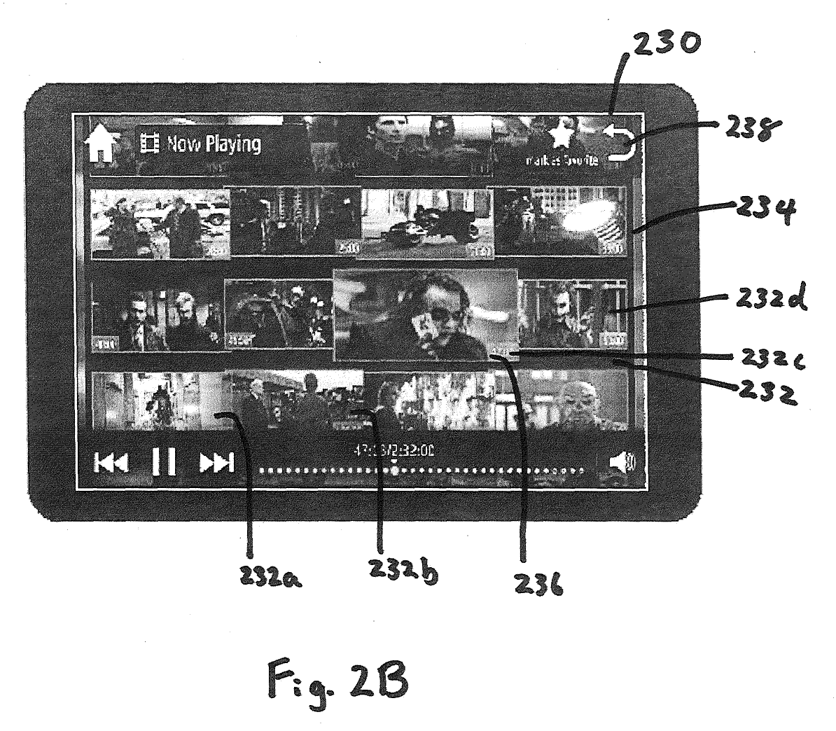

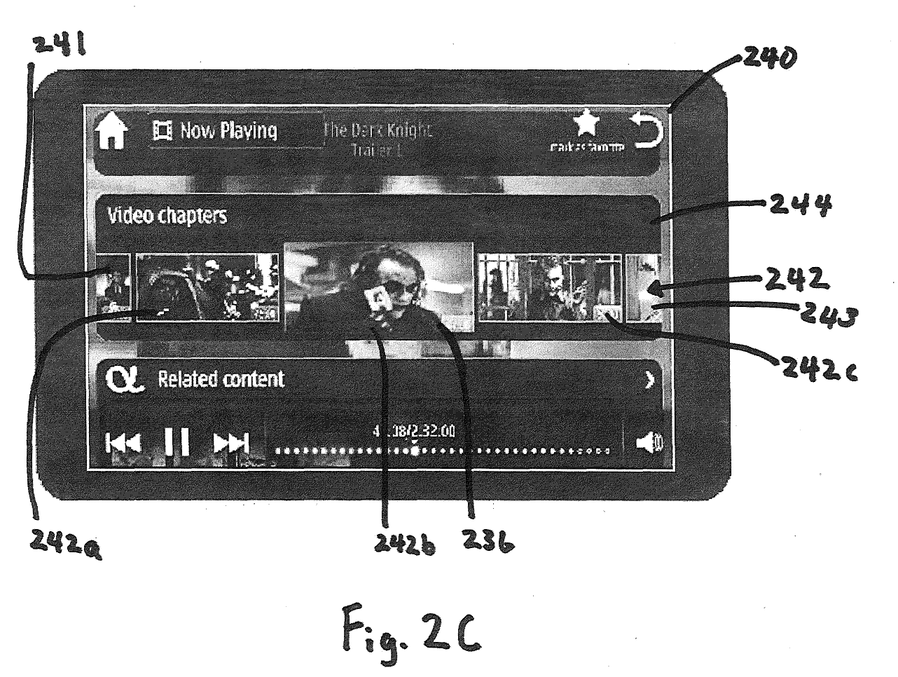

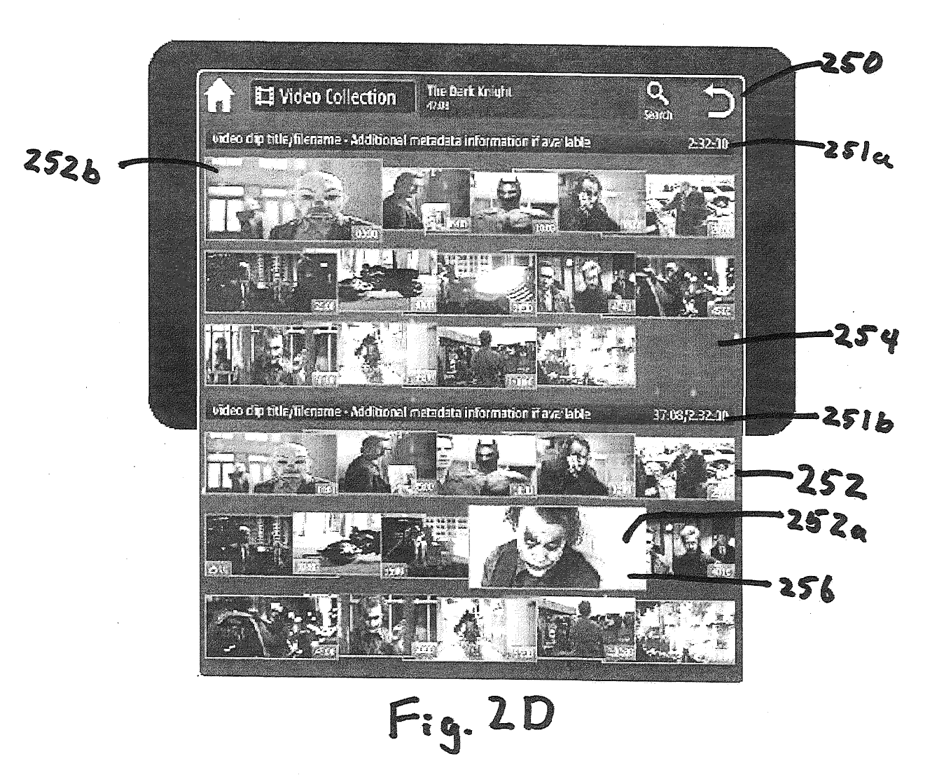

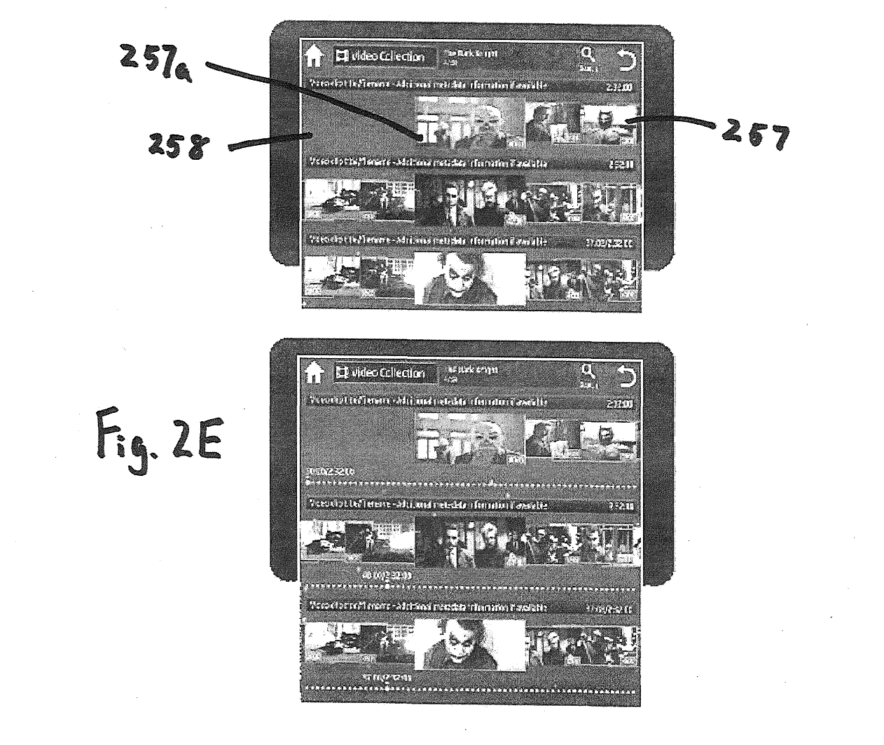

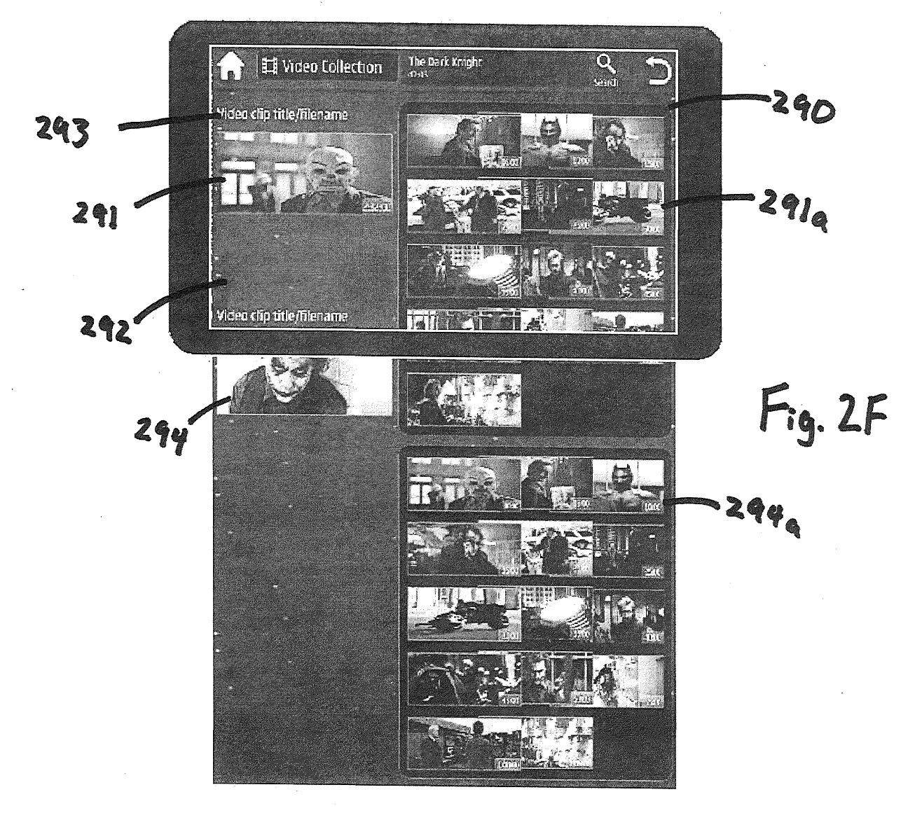

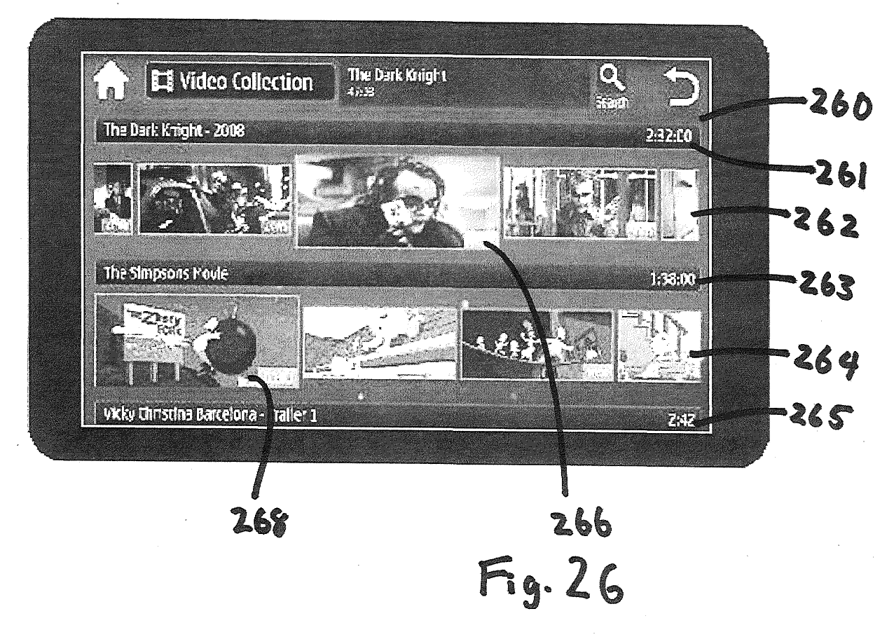

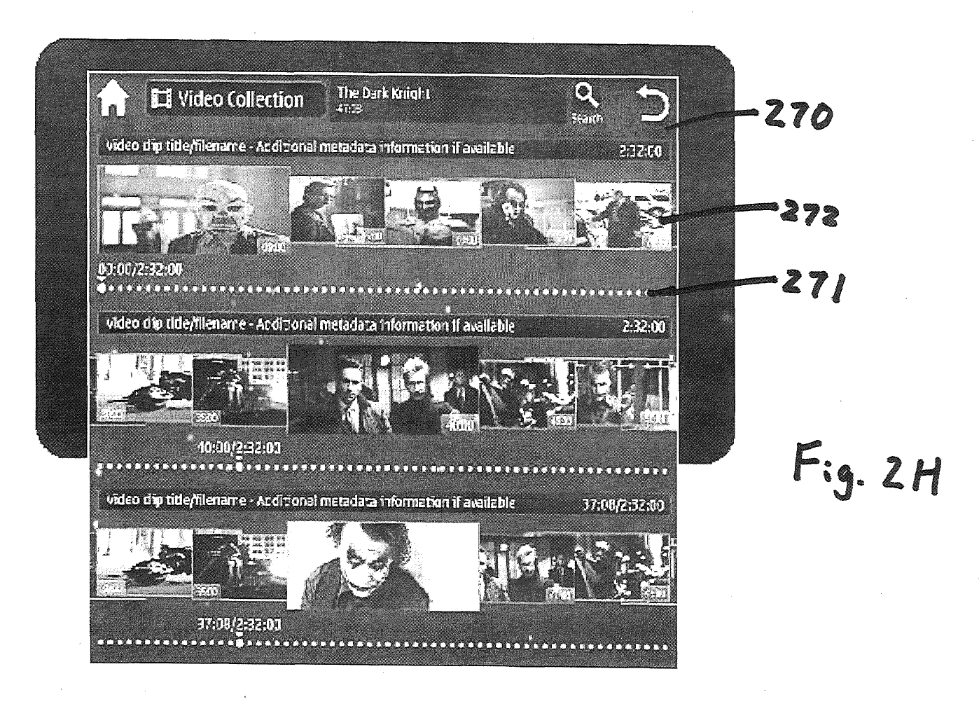

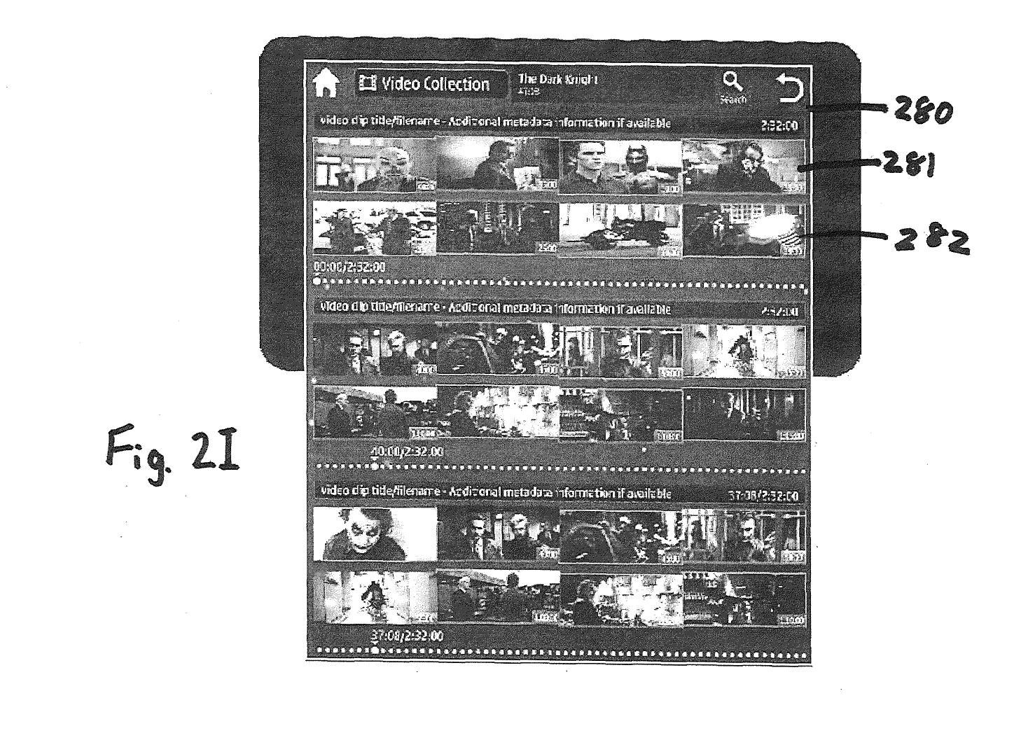

Each thumbnail, such as thumbnail 210a in FIG. 2A, presents an image pertaining to the underlying video clip. In this example, the video chapters are presented in a details layer below the currently played video clip. In one embodiment, a separate details view can be launched from the video player toolbar or menu 206 that includes the same functionality. The thumbnail presentation module 140 is generally configured to present the thumbnails on the user interface 106 of the device 120. FIG. 2A illustrates an embodiment where thumbnails 210a-210n are presented as chapters in a details layer view. The presentation module 140 can also be configured to present each of the thumbnails in a grid format, such as that seen in FIG. 2B, or in a filmstrip presentation format, such as that shown in FIG. 2C. In alternate embodiments, the thumbnail presentation module 140 can be configured to present the video chapter thumbnails in any suitable fashion.

In one embodiment, the processor module 122 also includes a chapter selection/playback module 142. The chapter selection/playback module 142 is generally configured to allow the selection of any chapter with which to start the video playback as well as jump between the created chapters, depending upon the chapter selection mode and user input.

Although the modules 136-142 are described above as separate modules, in one embodiment, each of the modules 136-142 is integrated into a single processing module. In alternate embodiments, the modules 136-142 can be combined or separated into any suitable number of modules.

FIG. 2A illustrates on example of the disclosed embodiments, where the video chapter thumbnails are viewable and accessible in a video player view of the device 120. In screen or user interface 200, a video 202 is shown being presented on the display 204. In this embodiment, the user interface 200 also presents a control menu 206, which can be selected in a known fashion, as indicated by circle 208, and dragged in an upwards direction as indicated by arrow A to open a details view as shown in screen 210.

The details view in screen 210 illustrates a container 212 including a number of thumbnails 210a-210n. In one embodiment, the container 212 can be sized according to the size and number of the thumbnails 210a-210×. In alternate embodiments, the container 212 can be of any suitable size, shape or dimension.

Each thumbnail 210a-210x represents a chapter of the video that is shown being presented in screen 200. In one embodiment, the currently playing position 214 is a live thumbnail, meaning that the video segment or chapter corresponding to the thumbnail 210n is actively playing on the screen 210. In alternate embodiments, the currently playing position can be either live or static video. In the embodiment shown in screen 210 of FIG. 2A, the currently playing position 214 is shown in the approximate center region of the screen 200. In alternate embodiment, the currently playing position 214 can be positioned at any suitable location on the screen 210.

The currently playing position 214 will generally be positioned between a thumbnail 214a and thumbnail 214b. Thumbnail 214a represents a chapter just prior to the chapter corresponding to thumbnail 210n, while thumbnail 214b represents a next chapter following the chapter corresponding to thumbnail 210n.

In order to select or jump to a new chapter, one of the thumbnails 210a-210x is selected. In one embodiment, this comprises touching or substantially contacting the desired thumbnail. The currently playing position 214 is shown with a live thumbnail 210n in screen 210 of FIG. 2A. To jump to a wanted chapter, the user can tap the desired chapter thumbnail.

In the example shown in FIG. 2A, the thumbnail 214b of screen 200 is selected as the next wanted chapter, which is then displayed in screen 220. As shown in screen 220 of FIG. 2A, the video player jumps to a beginning of the video chapter corresponding to the thumbnail 214b and presents the video player display mode 216. In one embodiment, the playback state of the device in screen 220 will be the same as the playback state in screen 200. For example, if the playback state in screen 200 was “play”, the video chapter shown on screen 220 corresponding to thumbnail 214b will be in the “play” state. However, if the playback state in screen 200 was “paused”, the playback state in screen 220 can also be “paused.” In alternate embodiments, the playback states between screens 200 to 220 can be configured in any suitable manner.

FIG. 2B illustrates an example of the disclosed embodiments where the thumbnails 232 are presented in a grid 234. In this embodiment, the thumbnails 232, such as for example thumbnail 232a and 232b are shown as partially overlapping. In alternate embodiments, the thumbnails 232 can be presented without any overlap.

The currently playing position, thumbnail 232c, is shown between its previous and next video chapter. As shown in FIG. 2B, the currently playing position, thumbnail 232c, is larger than other thumbnails. In alternate embodiments, the currently playing position can be emphasized or highlighted in any suitable fashion.

In one embodiment, the thumbnails of key frames or chapters of the video clip can be emphasized or highlighted in some fashion. For example, the thumbnails of key frames can be different sizes or shapes, highlighted, grayed out or contain certain markings. A key frame or chapter can include, for example, a chapter that has been viewed often by the user or by others, a chapter that is connected to, or contains a link to a service, the closer a chapter is to a currently played position, or a chapter that is designated to include a key scene, or key actors. In alternate embodiments, a key chapter can include any desired subject matter and any variable characteristic of the thumbnail can be varied. As another example, if a user has not watched a chapter, the thumbnail for that chapter could be grayed out.

In one embodiment, thumbnails that have not been viewed can be grayed-out. This can provide privacy, shielding or protection of content that has not yet been viewed, such as seeing a later part or end of a movie before the user is ready. For example, thumbnail 232c is currently playing as shown in FIG. 2B. Thumbnail 232d, which has not yet been viewed, can be grayed-out or the content or image otherwise protected from being immediately viewed by the user. In one embodiment, a marker or additional information field can be provided in conjunction with the grayed-out thumbnail in order to provide some identification as to the content of the chapter associated with the thumbnail. In another embodiment, when the pointing device, such as the user's finger, is moved to the grayed-out thumbnail, the thumbnail can be restored to its normal view. A “mouse-over” will quickly allow the user to see the underlying content. If the pointing device is moved away from the thumbnail without selecting the thumbnail, the thumbnail will again be grayed-out. The “gray-out” can be any suitable highlighting that at least partially blocks the underlying content from being viewed.

In one embodiment, a thumbnail 232, such as thumbnail 232b, could be a still frame or could also be a movie. For example, thumbnail 232b could capture key frames from the surrounding “x” number of minutes of the key frame currently in view. The thumbnail 232b could also capture text or information related to a service. In one embodiment, the thumbnail 232b could be a rating of this part of the movie, as compared to other parts, when the device 120 includes a service enabled video player. In alternate embodiments, the thumbnails can include attributes such as ratings or a description, that might be taken into consideration when selecting a thumbnail. As shown in FIG. 2B, the video clip corresponding to the currently playing position, thumbnail 232c, is live, with playback continuing within the thumbnail 232c, also referred to as background video playback. When the playback of the video associated with thumbnail 232c is complete, the currently playing position moves to the next chapter, which in this example would be thumbnail 232d. Thumbnail 232c would return to a smaller size, while the size of thumbnail 232d would expand, to indicate that thumbnail 232d is now the currently playing position. In one embodiment, the currently playing position 236 remains substantially stationary on the screen 230. When a chapter playback is complete, each thumbnail 232 advances to move the next thumbnail to be played into the currently playing position 238.

FIG. 2B also illustrates how certain marking controls and functions can be used in connection with the thumbnails 232. For example, if a user wants to mark a particular thumbnail as a “favorite”, option 238 “mark as favorite” can be activated. This can allow the user to easily recall certain thumbnails for playback.

FIG. 2C illustrates an example of a screen 240 in which a series of thumbnails 242 are in a film strip presentation style video player view 244. In this embodiment, the film strip 244 is pannable, meaning that it can be scrolled left and right. For example, the user can pan the film strip left and right using left and right stroke gestures, respectively. In one embodiment, the currently playing position 236, which is also live, is presented in the approximate center of the film strip 244. In this example, shown in FIG. 2C, the currently playing position 236 is a larger thumbnail, 242b, than the other thumbnails, such as 242a and 242c. In one embodiment, the film strip 244 can be visualized in an up/down style, so that panning occurs with up/down strokes, rather than left/right gestures.

In FIG. 2C, the currently playing position 236 is presented along with two previous and two next chapter thumbnails from the video clip. The two previous chapters include thumbnail 242a, and partial thumbnail 241. The two next chapters include thumbnail 242c and partial thumbnail 243. In alternate embodiments, any suitable number of whole or partial thumbnails can be presented in conjunction with a currently playing thumbnail 236.

As the playback of the video clip associated with the currently playing position 236 ends, in one embodiment the film strip 244 advances or rolls so that the currently playing position 236 remains substantially stationary, and the thumbnails 242 move. In this way, the former next chapter 242c moves into the currently playing position 236 for playback.

FIG. 2D illustrates an embodiment of a grid style presentation of thumbnails 252 in a screen 250. In this embodiment, the thumbnails 252 are presented as a video collection. In this example, the video chapters are shown using a grid 254, where the thumbnails 252a corresponding to the currently playing position 256 is larger in size than the other thumbnails. In this example the thumbnails 252 are all overlapping to some degree.

The screen 250 also includes title lines 251a and 251b. Each title line 251a, 251b includes a video clip title and filename. Additional metadata information can also be included, such as for example, an elapsed time and a total time of the video. In alternate embodiments, any suitable information can be included in the title lines.

In the example of FIG. 2D, the currently playing position 256 is shown between the corresponding previous and next chapter thumbnails as a larger thumbnail 252a. In the event that a thumbnail 252 is not selected for playback, in one embodiment, the first chapter thumbnail, 252b, is automatically selected as the current playing position 256, and the thumbnail 252 is enhanced or reconfigured to be larger. The current playing position 256 can also be the point in the video being played in the background or the stored seek position. The stored seek position is generally the point where the user closes the video player when watching the video.

In one embodiment, if the video clip does not have a stored seek position, or a thumbnail is not automatically selected, referring to FIG. 2E, then the first frame 257a of the video clip strip 257 will be shown in the middle of the video clip strip 257 as a bigger thumbnail, and the left side 258 of the first frame 257 is empty.

In FIG. 2F, the currently stored seek position 291 (or selected video chapter clip) is shown as a larger thumbnail and position in a viewing area 292 on the left side of the screen 290. In this example, a title 293, or other naming information, can be provided along a top part of the viewing area 292. The embodiment shown in FIG. 2F allows the user to browse video clips and chapters belonging to video clips from the same user interface screen 290. For example, as shown in FIG. 2F, the left side, or viewing area 292 of the screen 290 includes the video clips, such as clip 291 and 294. The user can pan the video clips along the viewing area 292, generally in an up and down direction. The respective video chapter thumbnails, 291a and 294a, are presented on the right side of the screen 290. As the user pans to the end of the thumbnails 291a of the currently video clip 291, the next video clip slides to the left into the viewing area 292, and its thumbnails are shown beginning on the right side.

FIG. 2G illustrates an example of a screen 260 in which thumbnails, such as thumbnails 262 and 264, are presented in a film strip presentation style in a video collection view. In this embodiment, the screen or view 260 includes titles 261, 263 and 265 that provide information and metadata related to the video clip. The currently playing position 266 is again shown in the approximate center of the film strip thumbnails 262 as a larger thumbnail. In the case a chapter is not selected for playback, the first chapter thumbnail, such as thumbnail 268, can be automatically selected for playback. The film strip presentation style shown in screen 260 allows the film strip to be panned left and right to view the thumbnails 262 related to the corresponding video clip. In one embodiment, the screen 260 can also be panned up and down to view additional video clips. The height of each thumbnail 262, 264 can be fixed in size so as to allow a predetermined number of film strips to be presented on the screen 260 at the same time.

FIG. 2H also illustrates a screen 270 with thumbnails in a film strip presentation style in a video collection view. In this embodiment, the film strip of thumbnails 272 is associated with a seek bar 271. The seek bar 271 can provide position indication and allows the user to browse the film strip by either panning the thumbnails 272 or tapping a position on the seek bar 271. In this embodiment, the thumbnails 272 are shown as overlapping. In alternate embodiments, the thumbnails can be visualized in any suitable manner, with or without overlapping.

In one embodiment, referring to FIG. 2I, unlike the previous examples which only included one row for each video clip, two rows of thumbnails, 281, 282, can be shown for each video clip. In this example, the rows of thumbnails 281, 282 can be panned left and right, as well as up and down.

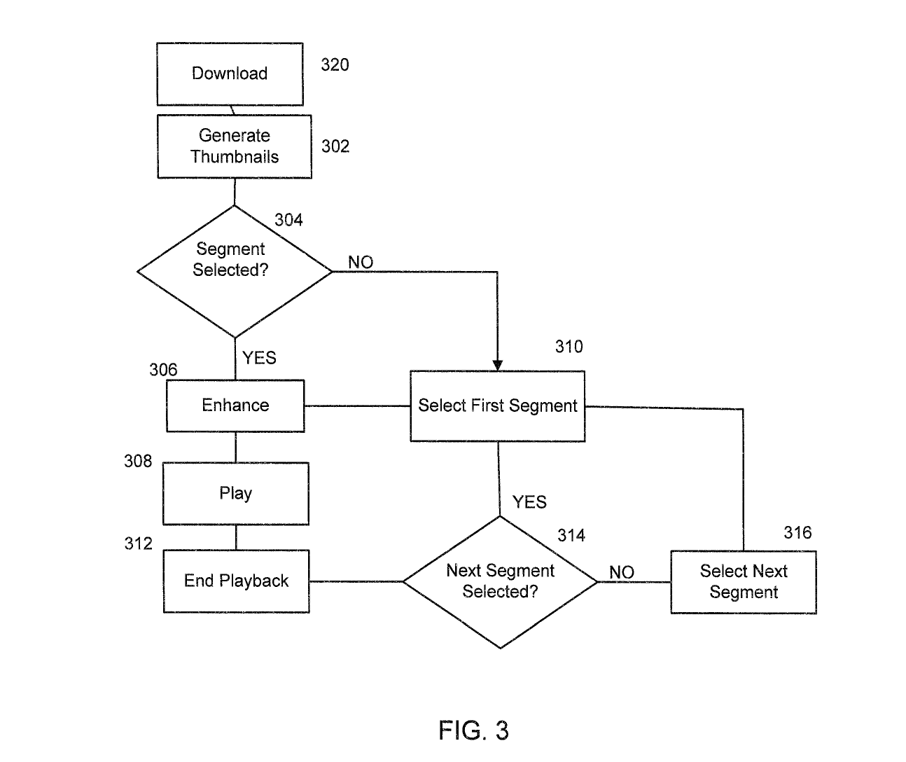

FIG. 3 illustrates a flowchart of a process incorporating aspects of the disclosed embodiments. A video clip is downloaded 300. The video clip is divided into segments and thumbnails corresponding to each segment are generated 302. It is determined whether 304 a segment is selected for playback. If yes, the thumbnail for the corresponding segment is enhanced 306 and playback begins 308. If a segment is not selected, in one embodiment, a first segment is selected 310. If playback ends 312, and another segment is not selected 314, the next segment is played 316. For example, in one embodiment, if a user selects a thumbnail to start playback, the playback continues automatically over the chapters until the user closes the video player. The user does not need to re-select another chapter after watching one video chapter. When a video clip is downloaded and chapters created, there is no stored seek position for the video clip because the user has not yet watched the video. Thus, in this example, the first chapter of the video clip is highlighted with an enhanced, or larger thumbnail.

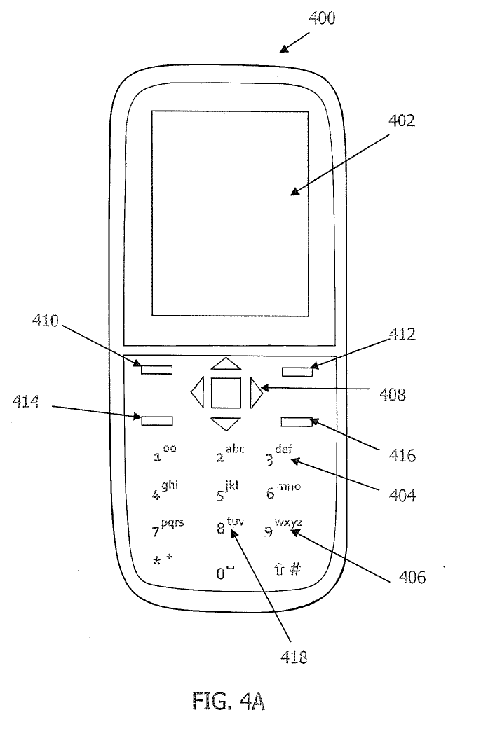

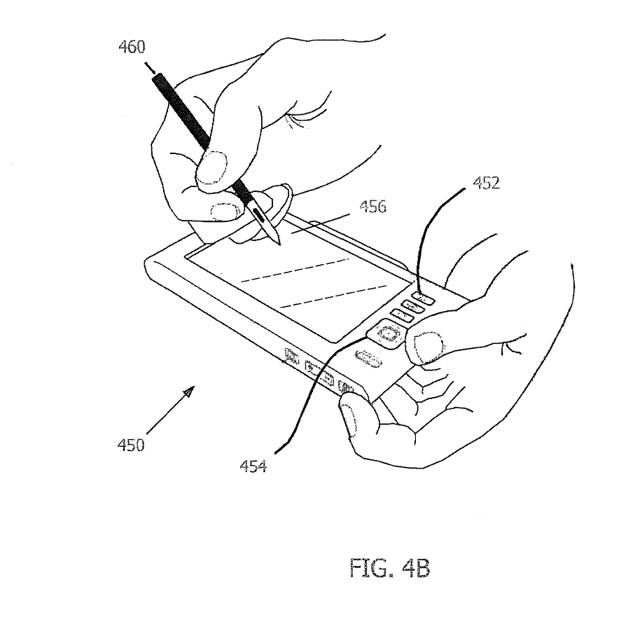

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 has a display area 402 and an input area 404. The input area 404 is generally in the form of a keypad. In one embodiment the input area 404 is touch sensitive. As noted herein, in one embodiment, the display area 402 can also have touch sensitive characteristics. Although the display 402 of FIG. 4A is shown being integral to the device 400, in alternate embodiments, the display 402 may be a peripheral display connected or coupled to the device 400.

In one embodiment, the keypad 406, in the form of soft keys, may include any suitable user input functions such as, for example, a multi-function/scroll key 408, soft keys 410, 412, call key 414, end key 416 and alphanumeric keys 418. In one embodiment, referring to FIG. 4B., the touch screen area 456 of device 450 can also present secondary functions, other than a keypad, using changing graphics.

As shown in FIG. 4B, in one embodiment, a pointing device, such as for example, a stylus 460, pen or simply the user's finger, may be used with the touch sensitive display 456. In alternate embodiments any suitable pointing device may be used. In other alternate embodiments, the display may be any suitable display, such as for example a flat display 456 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, the device 400 can include an image capture device such as a camera 420 (not shown) as a further input device. The device 400 may also include other suitable features such as, for example a loud speaker, tactile feedback devices or connectivity port. The mobile communications device may have a processor or other suitable computer program product connected or coupled to the display for processing user inputs and displaying information on the display 402 or touch sensitive area 456 of device 450. A computer readable storage device, such as a memory may be connected to the processor for storing any suitable information, data, settings and/or applications associated with each of the mobile communications devices 400 and 450.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the device 120 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In one embodiment, the touch screen display 456 can include the QWERTY keypad as discussed herein. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display and supported electronics such as a processor(s) and memory(s). For example, a user can browse DVD's on a PC or DVD player using the aspects of the disclosed embodiments. In one embodiment, these devices will be Internet enabled and include GPS and map capabilities and functions.

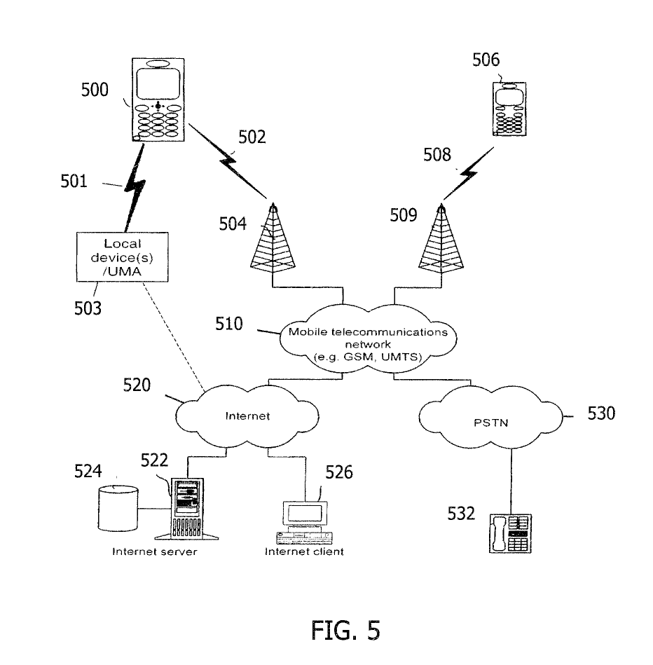

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the communication module 134 of FIG. 1 is configured to interact with, and communicate with, the system described with respect to FIG. 5.

Without in any way limiting the scope, interpretation, or application of the claims appearing below, a technical effect of the one or more example embodiments disclosed herein is the ability to browse any video clip in a mobile device, in a way that is similar to browsing DVD chapters in a DVD player, without the need for using a desktop computer. The video clip is downloaded to the mobile device and divided into segments of a fixed length. The segments are then presented in a fashion that allows for the video clips associated with each segment to be viewed.

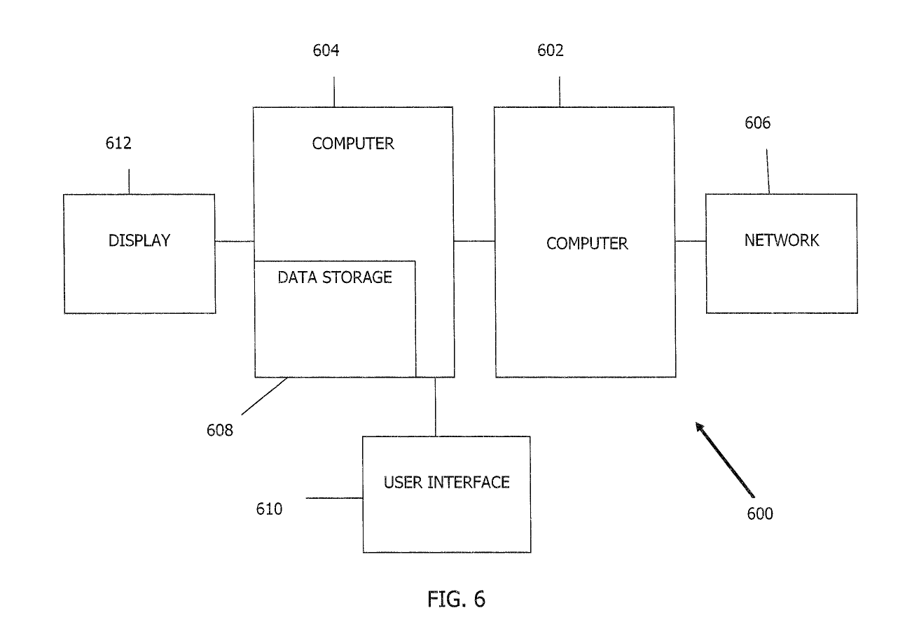

The aspects of the disclosed embodiments may be implemented in software, hardware, application logic or a combination of software hardware and application logic. The software, application logic and/or hardware may reside on one or more computers as shown in FIG. 6. If desired, part of the software, application logic and/or hardware may reside on one computer 602, while part of the software, application logic and/or hardware may reside on another computer 604. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer readable storage medium that may be any media or means that can contain or store the instructions for use by or in connection with an instruction execution system, apparatus or device, such as a computer.

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practice aspects of the invention. The apparatus 600 can include computer readable program code means embodied or stored on a computer readable storage medium for carrying out and executing the process steps described herein. In one embodiment the computer readable program code is stored in a memory(s) of the device. In alternate embodiments the computer readable program code can be stored in memory or other storage medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is configured to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor(s) for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for is the ability to browse any video clip in a mobile device, in a way that is similar to browsing DVD chapters in a DVD player, without the need for using a desktop computer. The video clip is downloaded to the mobile device and divided into segments of a fixed length. The segments are then presented in a fashion that allows for the video clips associated with each segment to be viewed.

It is noted that the embodiments described herein can be used individually or in any combination thereof. If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the invention as defined in the appended claims.

What is claimed is:

1. A method comprising:
detecting a video clip in a mobile communication device;
generating video chapter thumbnails from the video clip;
providing the video chapter thumbnails in a video player user interface of the mobile communication device, and
wherein selection of a video chapter thumbnail will enable a playback from a corresponding video clip chapter.

2. The method of claim 1 further comprising that a currently playing video clip chapter is presented as a live video thumbnail between a previous chapter thumbnail and a next chapter thumbnail.

3. The method of claim 1 wherein a video chapter thumbnail for the currently playing video clip chapter is larger relative to other video chapter thumbnails.

4. The method of claim 1 wherein playback of the corresponding video clip chapter occurs within a boundary of the selected video chapter thumbnail.

5. The method of claim 1 wherein a sequence of video chapter thumbnails presented on the user interface corresponds to a sequence of chapters of the video clip.

6. The method of claim 1 wherein the video chapter thumbnails are presented in a grid presentation style or a film strip view in the video player user interface.

7. The method of claim 1 further comprising, moving a currently playing thumbnail position to a next video chapter thumbnail when a seek position detects a start position of a next video chapter.

8. The method of claim 1 further comprising presenting the video chapter thumbnails as a pannable filmstrip, including a currently playing video chapter thumbnail position and at least one previous video chapter thumbnail and at least one next video chapter thumbnail.

9. The method of claim 8 further comprising that the currently playing video chapter thumbnail position is enhanced and/or highlighted relative to the at least one previous video chapter thumbnail and the at least one next video chapter thumbnail.

10. The method of claim 8 further comprising shifting the pannable filmstrip as an end of a currently playing video chapter ends, wherein the currently playing video chapter thumbnail position remains in an approximate center region of the pannable filmstrip.

11. The method of claim 8 further comprising panning the pannable film strip in a left or right direction in response to a detection of a left or right input gesture on the user interface.

12. An apparatus comprising:
a processor configured to:
detect a video clip in a mobile communication device;
generate video chapter thumbnails from the video clip;
provide the video chapter thumbnails in a video player user interface of the mobile communication device, and
wherein selection of a video chapter thumbnail will enable a playback from a corresponding video clip chapter.

13. The apparatus of claim 12 wherein the processor is further configured to present a currently playing video clip chapter as a live video thumbnail between a previous chapter thumbnail and a next chapter thumbnail.

14. The apparatus of claim 12 wherein a video chapter thumbnail for the currently playing video clip chapter is larger relative to other video chapter thumbnails.

15. The apparatus of claim 12 wherein playback of the corresponding video clip chapter occurs within a boundary of the selected video chapter thumbnail.

16. The apparatus of claim 12 wherein a sequence of video chapter thumbnails presented on the user interface corresponds to a sequence of chapters of the video clip.

17. The apparatus of claim 12 wherein the processor is further configured to present the video chapter thumbnails in a grid presentation style or a film strip view in the video player user interface.

18. The apparatus of claim 12 wherein the processor is further configured to move a currently playing thumbnail position to a next video chapter thumbnail when a start position of a next video chapter is detected.

19. A computer program product comprising a computer readable storage medium bearing computer program code embodied therein for use with a computer, the computer program code comprising:
code for detecting a video clip in a mobile communication device;
code for generating video chapter thumbnails from the video clip;
code for providing the video chapter thumbnails in a video player user interface of the mobile communication device, and
wherein selection of a video chapter thumbnail will enable a playback of a corresponding video clip chapter.

20. The computer program product of claim 19 further comprising code for presenting a currently playing video clip chapter as a live video thumbnail between a previous chapter thumbnail and a next chapter thumbnail.
